(19) United States
(12) Patent Application Publication
(10) Pub. No.: US 2023/0236431 A1
(43) Pub. Date: Jul. 27, 2023

(54) DEVICE FOR GENERATING A LASER LINE ON A WORK PLANE

(71) Applicant: TRUMPF LASER- UND SYSTEMTECHNIK GMBH, Ditzingen (DE)

(72) Inventors: Andreas Heimes, Renningen (DE); Julian Hellstern, Rottweil (DE); Martin Wimmer, Gerlingen (DE)

(21) Appl. No.: 18/193,737

(22) Filed: Mar. 31, 2023

Related U.S. Application Data
(63) Continuation of application No. PCT/EP2021/077644, filed on Oct. 7, 2021.

(30) Foreign Application Priority Data
Oct. 7, 2020 (DE) 10 2020 126 267.1

(51) Int. Cl. G02B 27/09; G02B 19/00

(52) U.S. Cl. CPC G02B 27/0927; G02B 27/0966; G02B 19/0061

(57) ABSTRACT

A device for generating a laser line on a work plane includes a first laser light source configured to generate a first raw laser beam, a second laser light source configured to generate a second raw laser beam, and an optical arrangement configured to reshape the first raw laser beam to form a first illumination beam with a first caustic and a first beam profile, and reshape the second raw laser beam to form a second illumination beam with a second caustic and a second beam profile. The first illumination beam and the second illumination beam are directed with overlap on the work plane and define a joint illumination direction. The first beam profile and the second beam profile jointly form the laser line on the work plane. The optical arrangement is configured to position the first caustic and the second caustic offset from one another in the illumination direction.

### CROSS REFERENCE TO RELATED APPLICATIONS

This application is a continuation of International Application No. PCT/EP2021/077644 (WO 2022/074095 A1), filed on Oct. 7, 2021, and claims benefit to German Patent Application No. DE 10 2020 126 267.1 filed on Oct. 7, 2020. The aforementioned applications are hereby incorporated by reference herein.

### FIELD

Embodiments of the present invention relate to a device for generating a laser line on a work plane, comprising a first laser light source configured to generate a first raw laser beam, comprising a second laser light source configured to generate a second raw laser beam, and comprising an optical arrangement having a first beam path which takes the first raw laser beam and reshapes the latter along a first optical axis to form a first illumination beam with a first caustic and a first beam profile and having a second beam path which takes the second raw laser beam and reshapes the latter along a second optical axis to form a second illumination beam with a second caustic and a second beam profile, the first and the second illumination beam being directed with overlap on the work plane and thus defining a joint illumination direction, the first and the second beam profile each having a long axis with a long-axis beam width and a short axis with a short-axis beam width perpendicular to the joint illumination direction, and the first and the second beam profile jointly forming the laser line on the work plane.

### BACKGROUND

A device for generating a laser line has been disclosed, for example, in US 2014/0027417 A1.

The line-shaped laser illumination of such a device is typically used to machine a workpiece. By way of example, the workpiece can be a plastics material on a glass plate that serves as a carrier material. In particular, the plastics material can be a film on which organic light-emitting diodes, so-called OLEDs, and/or thin-film transistors are produced. OLED films are used for modern displays in smartphones, tablet PCs, televisions, and other equipment with a visual display unit. Following the production of the electronic structures, the film must be detached from the glass carrier. This can be implemented using a laser illumination in the form of a thin laser line which is moved at a defined speed relative to the glass plate and removes the adhering connection of the film through the glass plate. In practice, such an application is frequently referred to as LLO or laser lift off.

Another application for the illumination of a workpiece with a defined laser line can be the line-by-line fusing of amorphous silicon on a carrier plate. In this case, the laser line is likewise moved at a defined speed relative to the workpiece surface. As a result of fusing, the comparatively cheap amorphous silicon can be converted into superior polycrystalline silicon. In practice, such an application is frequently referred to as solid state laser annealing or SLA.

Such applications require a laser line on the work plane which is as long as possible in one direction in order to capture a work area that is as wide as possible and which, by comparison, is very short in the other direction in order to provide an energy density required for the respective process. A device capable of generating a long thin laser line parallel to a work plane is therefore desirable. The direction of the extent of the laser line is usually referred to as the long axis and the line thickness is referred to as the short axis of what is known as the beam profile. As a rule, the laser line should have a defined intensity profile along both axes. By way of example, it is desirable for the laser line to have an intensity profile along the long axis which is as rectangular or possibly trapezoidal as possible, with the latter possibly being advantageous if a plurality of such laser lines should be strung together to form a longer overall line. Depending on the application, a rectangular intensity profile (known as a top hat profile), a Gaussian profile, or any other intensity profile is desired along the short axis.

WO 2018/019374 A1 discloses a suitable device with numerous details relating to the optical elements of the optical arrangement. A laser source generates a raw laser beam which is fanned very widely in a first spatial direction with the aid of what is known as a beam transformer and which is subsequently homogenized in order to obtain the long axis. The laser beam is focused in a second spatial direction perpendicular thereto in order to obtain the short axis. The first and the second spatial direction are perpendicular to the beam direction, in which the laser beam is incident on the work plane. One exemplary embodiment indicates that a plurality of such laser lines may be arranged next to one another in the direction of the respective long axes in order thus to form a very long laser line. Thus, two parallel illumination beams, which each form a laser line on a work surface, are offset in the direction of the long axes in this exemplary embodiment.

Aforementioned US 2014/0027417 A1 discloses a device of the type set forth at the outside, wherein the first illumination beam and the second illumination beam are offset from one another in the direction of the respective short axis. In this case, the first and the second beam profile jointly form a laser line with a step-shaped intensity profile in order thus to adapt the energy input into the workpiece to the changing material properties over the course of the laser machining.

DE 10 2018 200 078 A1 discloses an optical arrangement for generating a laser line using a telescope arrangement which has an optical refractive power in relation to the short axis. The telescope arrangement contains a first lens group and a second lens group which are movable relative to one another along the optical axis. A control unit controls the movement while the laser beam source generates the laser beam so as to keep the intensity of the laser line and its so-called full width at half maximum (FWHM), that is to say the line width at 50% of the intensity, as constant as possible over time. It was found that the properties of the optical arrangement may change during the generation of the laser beam. In particular, what are known as thermal lenses may form as a result of the optical elements heating up as a consequence of the laser beam, and these thermal lenses change the optical properties of the arrangement. To compensate for or at least reduce the change in the focal position arising therefrom, DE 10 2018 200 078 A1 proposes a displacement of the telescope lenses relative to one another.

### SUMMARY

Embodiments of the present invention provide a device for generating a laser line on a work plane. The device includes a first laser light source configured to generate a first raw laser beam, a second laser light source configured to generate a second raw laser beam, and an optical arrangement. The optical arrangement is configured to transport the first raw laser beam along a first beam path, and reshape the first raw laser beam along a first optical axis to form a first illumination beam with a first caustic and a first beam profile, and transport the second raw laser beam along a second beam path, and reshape the second raw laser beam along a second optical axis to form a second illumination beam with a second caustic and a second beam profile. The first illumination beam and the second illumination beam are directed with overlap on the work plane and define a joint illumination direction. The first beam profile and the second beam profile each has a long axis with a long-axis beam width and a short axis with a short-axis beam width perpendicular to the joint illumination direction. The first beam profile and the second beam profile jointly form the laser line on the work plane. The optical arrangement is configured to position the first caustic and the second caustic offset from one another in the illumination direction.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIGS. 1a and 1b show a simplified illustration of a first exemplary embodiment of the device;

FIG. 2 shows a simplified illustration of a beam profile for the purpose of explaining the first exemplary embodiment and further exemplary embodiments;

FIG. 3 shows a simplified representation of two beam waists that are arranged offset from one another in the illumination direction in accordance with a few exemplary embodiments of the device;

FIGS. 4a and 4b show a schematic illustration of a second exemplary embodiment of the device;

FIG. 5 shows a much simplified illustration for the purpose of explaining a further exemplary embodiment of the device; and

FIGS. 6a and 6b show a schematic illustration of a further exemplary embodiment of the device.

### DETAILED DESCRIPTION

A disadvantage of this solution can be found in the mechanical outlay required for the positional adjustment of the telescope lenses. The movement may lead to wear and tear and/or have a misalignment of the optical arrangement as a consequence. Embodiments of the present invention provide a device that makes an alternative contribution to keeping the work plane in the work range of the device.

According to one aspect of the present invention, a device is provided, in which the optical arrangement is configured to position the first caustic and the second caustic offset from one another in the illumination direction.

The caustic of a laser beam represents the profile of the beam diameter from the output of the optical arrangement to what is known as the beam focus, that is to say the location of minimum beam diameter, and moreover in the illumination direction or beam propagation direction. The beam focus is frequently also referred to as the beam waist, and so the caustic contains the beam waist of the laser beam. Accordingly, in particular the beam waists of the first and the second illumination beam are offset relative to one another in the illumination direction or beam propagation direction in preferred exemplary embodiments. In these exemplary embodiments, the optical arrangement is consequently configured to position the beam waist of the first illumination beam (first beam waist) and the beam waist of the second illumination beam (second beam waist) offset from one another in the illumination direction. In the preferred exemplary embodiments, the first caustic and the second caustic are offset from one another especially when observing the caustics along the short axis in the illumination direction but are not offset or at best marginally offset from one another when observing the caustics along the long axis.

The device allows a relative mechanical adjustment of the optical arrangement or optical elements which bring about focusing of the beam profile along the short axis to be dispensed with because the offset caustics are overlaid along the short axis (and also along the long axis). As a consequence, the process window for machining a workpiece is increased. Even in the case of a focal drift as a consequence of thermal lenses or other effects, the workpiece can be kept within the process window during the laser operation without a mechanical readjustment.

Therefore, the optical elements which have an optical refractive power in relation to the short axis of the beam profile preferably have fixed distances relative to one another. Each optical element is stationary in some preferred exemplary embodiments. This reduces mechanical wear and tear and also reduces the risk of the optical arrangement being able to be misaligned as a consequence of a mechanical movement.

Rather, the device is based on the concept of increasing the process window in the beam direction, sometimes also referred to as longitudinal, by at least 2 overlaid and mutually offset caustics in a targeted manner. In preferred exemplary embodiments, the device therefore deliberately accepts a focal drift as a consequence of the optical elements being heated depending on operating power and/or operating duration of the laser light sources. However, the optical arrangement has been configured in a targeted manner to reduce the beam quality of the jointly formed beam profile, in particular along the short axis, with the result that the beam profile remains in the process window even in the case of a focal position drift. Instead of having mechanical tracking, the optical arrangement has been designed in a targeted manner for a greater depth of field as a result of the two mutually offset caustics.

Therefore, the device comprises an optical arrangement in which the relationship between depth of field and focal shift has been positively influenced. The process window of the device has been increased in comparison with devices from the prior art. Mechanical tracking and the disadvantages connected therewith can be avoided. Accordingly, the aforementioned object has been completely achieved.

In a preferred configuration, the optical arrangement comprises a first beam transformer in the first beam path and a second beam transformer in the second beam path, the first beam transformer reshaping the first raw laser beam in order to generate the first beam profile, the second beam transformer reshaping the second raw laser beam in order to generate the second beam profile, the first optical axis and the second optical axis defining a joint system axis, and the first beam transformer and the second beam transformer being arranged offset relative to one another along the joint system axis.

In this configuration, the offset of the first caustic relative to the second caustic is obtained by virtue of a “dedicated” beam transformer being provided for each illumination beam, with the (at least) two beam transformers being arranged offset from one another along the joint system axis. This configuration is advantageous in that the first and the second beam path can otherwise have an identical realization. In particular, the optical elements of the arrangement which influence the two partial laser beams and thus form the (at least) two illumination beams can be positioned parallel to one another. This simplifies production and maintenance of the device. Moreover, the jointly formed beam profile along the long axis is hardly influenced in this configuration.

In a further configuration, the optical arrangement contains at least one beam transformer which reshapes the first raw laser beam and/or the second raw laser beam in order to generate the corresponding first and/or second beam profile, and the optical arrangement comprises in the second beam path an optical element which offsets the second caustic relative to the first caustic.

In this embodiment, the offset of the first caustic relative to the second caustic is achieved by virtue of the second beam path comprising at least one additional optical element in comparison with the first beam path. Accordingly, the first and the second beam path may differ. The additional optical element may be arranged upstream or downstream of the at least one beam transformer. Accordingly, exemplary embodiments of this configuration may in principle contain a joint beam transformer for both illumination beams, with the result that the beam paths for the first and the second illumination beam only differ downstream of the joint beam transformer. The optical arrangement contains a beam transformer in each of the first and second beam paths in other exemplary embodiments of this configuration. In some preferred exemplary embodiments of this configuration, the additional optical element can be a telescope which displaces the position of the second caustic in comparison with the position of the first caustic. An advantage of this configuration is that the additional optical element allows the device to be realized relatively easily on the basis of available designs.

In a further configuration, the first caustic defines a process window with a process window length in the illumination direction, and the first caustic and the second caustic are offset from one another in the illumination direction by a defined distance which is less than 1.5-times the process window length and greater than 0.5-times the process window length, preferably less than 1.2-times the process window length and greater than 0.8-times the process window length, and particularly preferably less than 1.1-times the process window length and greater than 0.9-times the process window length.

In this configuration, the offset of the caustics relative to one another is of the order of the depth of field of the optical arrangement. In this case, the depth of field can be defined by way of the percentage deviation of the beam width FWHM along the short axis in the illumination direction. In particular, the depth of field can be defined as the distance between those points of the short-axis caustic at which the short-axis beam width has increased by 1% or any other percentage between 1% and 10% in comparison with the short-axis beam width at the beam waist. Complicated analyses have shown that the configuration has very advantageous dimensioning for the offset of the second caustic relative to the first caustic since it enables a relevant increase of the process window with a relatively small effect on the long axis of the beam profile, and hence on the quality of the laser line.

In a further configuration, the optical arrangement comprises at least one lens which has a predominant optical refractive power in relation to the short axis of the first and the second beam profile, the lens having an effective diameter in relation to the short axis, and the first and/or the second illumination beam illuminating the lens over more than 50%, preferably more than 70%, and further preferably more than 90% of the effective diameter.

In this configuration, the at least one lens is illuminated over a larger area than is conventional in known devices. In other words, the at least one lens is illuminated into its peripheral region. The extensive illumination of the at least one lens by the laser beam to be focused firstly has as a consequence that the at least one lens is subject to less pronounced local heating. Accordingly, this configuration advantageously contributes to reducing the formation of thermal lenses and the focal drift during the operation of the device. Moreover, this configuration enables a more compact structure of the device since the offset of the caustics can advantageously be of the order of the depth of field and can accordingly be chosen to be smaller in the case of a lesser depth of field. The imaging scale of the optical arrangement then for example also allows the aforementioned offset of the first beam transformer relative to the second beam transformer to be chosen to be smaller. This configuration is particularly advantageous for SLA applications and, more generally, for applications where the beam profile has a top hat characteristic along the short axis.

In a further configuration, the first beam path generates a first intermediate image, the second beam path generates a second intermediate image, and the first optical axis and the second optical axis define a joint system axis, the first and the second intermediate image being arranged offset relative to one another along the joint system axis.

This configuration is also particularly advantageous for applications where the beam profile has a top hat characteristic along the short axis. The relative offset between the caustics can easily be obtained here by a displacement of the intermediate image. The process window or the position of the waist within the process window of each beam path defines a conjugate plane upstream of the objective. This can be displaced by advantageous configurations of the upstream optical unit. In some preferred exemplary embodiments, the optical arrangement contains in the second beam path a short-axis telescope which is displaced along the joint system axis in comparison with the corresponding short-axis telescope in the first beam path. Advantageously, this displacement can be implemented during the assembly and adjustment of the device, enabling a cost-effective realization. Preferably, the displacement is realized while observing the telecentricity condition. The configuration generates disjoint image positions of the first and second caustic.

In a further configuration, the optical axis comprises a first beam transformer in the first beam path and a second beam transformer in the second the beam path, the second beam transformer being rotated relative to the first beam transformer about the second optical axis.

Preferably, the optical arrangement in this configuration contains a collimation optical unit with a number of lenses which collimate the respective raw laser beam before it is incident on the respective beam transformer. Advantageously, at least one of the lenses in the second beam path is displaced along the second optical axis relative to the corresponding lens in the first beam path, resulting in different collimations of the respective raw laser beam in the parallel beam paths. This configuration enables a very efficient relative displacement of the beam caustics.

In a further configuration, the optical arrangement focuses the first and the second beam profile onto the work plane, with neither the first nor the second beam path having a determined stop.

This configuration is particularly advantageous for LLO applications. As a result of dispensing with a determined stop, for instance a slit diaphragm, it enables an efficient transfer of the laser energy to the work plane with few losses.

In a further configuration, the optical arrangement superposes the first and the second beam profile along the respective long axis and along the respective short axis.

In this configuration, the first and the second beam profile are largely above one another, in particular over more than 90%, both along the long axis and along the short axis. They form the laser line superposed both along the long axis and along the short axis. The configuration advantageously contributes to a very homogeneous intensity distribution along the long axis and to a defined intensity profile along the short axis.

It is understood that the aforementioned features and the features yet to be explained below are usable not only in the respectively specified combination but also in other combinations or on their own, without departing from the scope of the present invention.

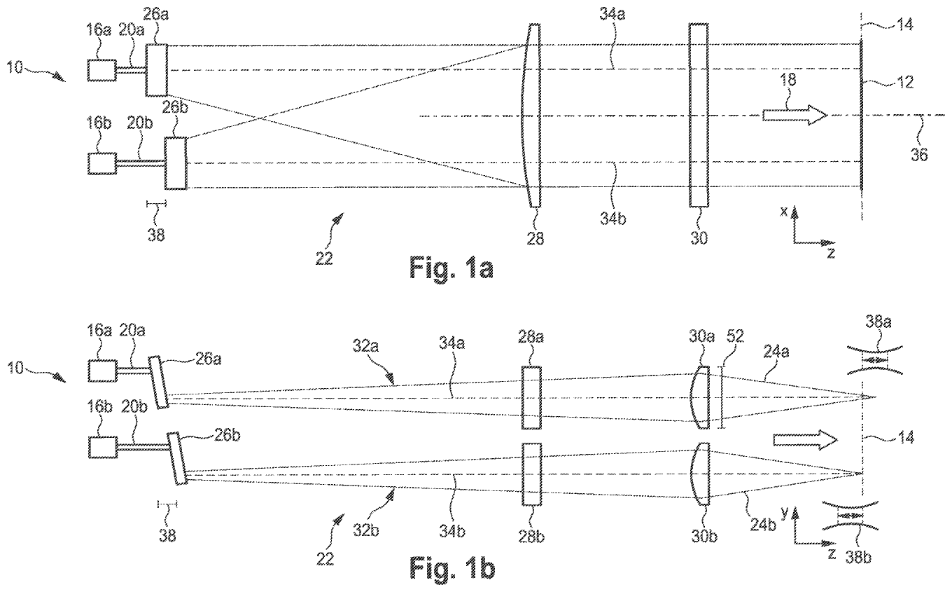

FIGS. 1a and 1b denote the entirety of a first exemplary embodiment of the device with reference sign 10. FIG. 1a shows the device 10 in a simplified illustration with a view from above on the laser line 12, placed here in the region of a work plane 14. The device 10 comprises a first laser light source 16a and a second laser light source 16b, each of which for example can be a solid-state laser, which generates laser light in the infrared range or in the UV range. By way of example, the laser light sources 16a, 16b may each contain a Nd:YAG laser with a wavelength of the order of 1030 nm. In further examples, the laser light sources 16a, 16b may contain diode lasers, excimer lasers, or solid-state lasers, which respectively generate laser light with wavelengths between 150 nm and 350 nm, 500 nm and 530 nm, or 900 nm to 1070 nm. Moreover, exemplary embodiments of the device may contain Nd:YAG lasers, diode lasers, excimer lasers, or solid-state lasers, the raw laser beam of which is divided into two partial beams, for instance using a splitter mirror (not depicted here), in order thus to provide two raw laser beams as input beams for the optical arrangement described below. Accordingly, the first laser light source 16a and the second laser light source 16b may represent a single laser light source with a downstream beam splitter element in some exemplary embodiments not depicted here. Further, exemplary embodiments of the device may contain more than only two laser light sources.

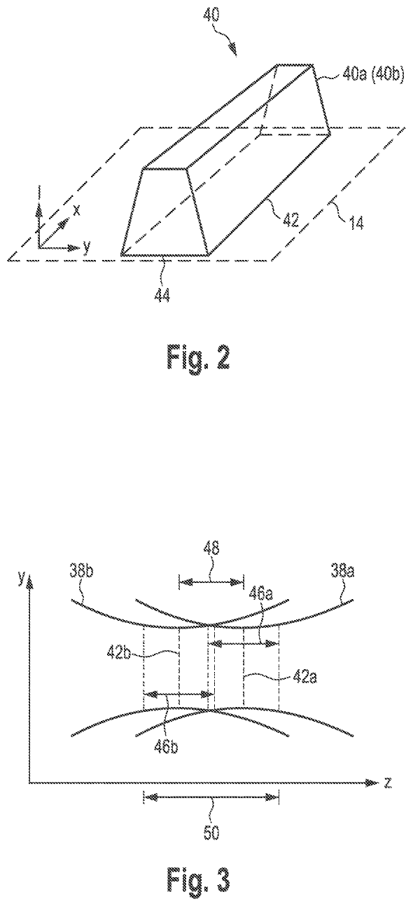

FIG. 1b shows the device 10 from the side, that is to say with a view of the short axis of the laser line 12. Below, the illumination direction 18 on the work plane 14 is denoted by the coordinate axis z. The laser line 12 extends in the direction of the x-axis and the line width is considered in the direction of the y-axis. Accordingly, the x-axis in the following denotes the long axis and the y-axis denotes the short axis of the beam profile formed on the work plane (FIG. 2).

In this case, the laser light sources 16a, 16b each generate a raw laser beam 20a, 20b. The two raw laser beams 20a, 20b are reshaped into illumination beams 24a, 24b using an optical arrangement 22. Here, the optical arrangement 22 contains a first beam transformer 26a, which expands the first raw laser beam 20a along the x-direction (corresponding to the long axis), and a second beam transformer 26b, which expands the second raw laser beam 20b along the x-direction. In preferred exemplary embodiments, the beam transformers 26a, 26b can each be realized like the beam transformers described in detail in WO 2018/019374 A1, which was mentioned at the outset. Accordingly, the beam transformers 26a, 26b can each contain a transparent, monolithic, planar element with a front side and a back side that are substantially parallel to one another. The planar element can be arranged at an acute angle (cf. FIG. 1b) with respect to the respective raw laser beam 20a, 20b. The front side and the back side may each have a reflective coating such that the respective raw laser beam 20a, 20b is obliquely coupled into the planar element at the respective front side and experiences multiple reflections within the planar element before it emerges, fanned open, at the back side of the planar element.

The optical arrangement 22 further contains a long-axis optical unit 28 having a multiplicity of optical elements 28a, 28b (depicted here in much simplified form), which further shape the reshaped first and the reshaped second raw laser beam 20a, 20b along the long axis. In particular, the long-axis optical unit 28 may in each case contain one or more microlens arrays (not depicted here) and one or more lenses with positive optical refractive power predominantly along the long axis for each raw laser beam 20a, 20b. In particular, the microlens arrays and the one or more lenses may each contain cylindrical lenses which extend along the y-axis and which have an optical refractive power substantially in relation to the long axis. In particular, the microlens arrays and the one or more lenses can form an imaging homogenizer which in each case homogenizes the raw laser beam 20a, 20b along the long axis in order to obtain an advantageous top hat intensity profile along the long axis in each of the two illumination beams 24a, 24b.

The optical arrangement 22 further contains a short-axis optical unit 30 having a multiplicity of optical elements 30a, 30b (depicted here in much simplified form), which further shape the reshaped first and the reshaped second raw laser beam 20a, 20b along the short axis. As is evident from FIG. 1b, the first beam transformer 26a, the optical elements of the long-axis optical unit 28a and the optical elements 30a of the short-axis optical unit form a first beam path 32a with a first optical axis 34a. The second beam transformer 26b, the optical elements of the long-axis optical unit 28b and the optical elements 30b of the short-axis optical unit form a second beam path 32b with a second optical axis 34b. The optical axes 34a, 34b run parallel to one another in some preferred exemplary embodiments. However, in principle, it is possible that the optical axes 34a, 34b run obliquely to one another. The optical axes 34a, 34b define a common system axis 36 which runs parallel to and centrally between the optical axes 34a, 34b in the shown exemplary embodiment. As a rule, the common system axis 36 coincides with the illumination direction 18. It may be an axis of symmetry of the device 10 and/or the optical arrangement 22.

As depicted in FIGS. 1a and 1b, the first beam transformer 26a and the second beam transformer 26b are arranged offset from one another by a distance 38 (related to the common system axis 36) in this exemplary embodiment. As a consequence, the beam paths 32a, 32b each generate a beam caustic 38a, 38b, with the beam caustics 38a, 38b being offset from one another (at least with respect to the short axis) in the illumination direction, as indicated in FIG. 1b. However, the beam caustics 38a, 38b are superposed in the region of the work plane and therefore form a joint beam profile.

FIG. 2 shows a simplified representation of such a beam profile 40. The beam profile 40 describes the intensity I of the laser radiation on the work plane 14 as a function of the respective position along the x-axis and the y-axis. As depicted, the beam profile 40 of the device 10 has a long axis 42 with a long-axis beam width in the x-direction and a short axis 44 with a short-axis beam width in the y-direction. By way of example, the short-axis beam width 33 can be defined as full width at half maximum (FWHM) or as width between the 90% intensity values (full width at 90% maximum, FW@90%). Deviating from the trapezoidal intensity profile along the short axis depicted here in simplified fashion, the beam profile 40 may be a Gaussian profile or a top hat profile (the latter naturally with a finite edge steepness in reality). On account of the ideally congruent superposition of the illumination beams 24a, 24b in the region of the work plane, the beam profile 40 is formed from two largely identical beam profiles 40a, 40b of the corresponding illumination beams 24a, 24b. To machine a workpiece (not depicted here), the beam profile 40 is typically moved transversely to the x-direction relative to the work plane 14, in particular in the y-direction.

FIG. 3 shows the superposition of the two mutually offset in a simplified illustration. Both of the two beam caustics 38a, 38b contains a beam waist 42a and 42b, respectively, at which the respective illumination beam 24a, 24b has the respective minimum beam diameter. Moreover, both of the two mutually offset beam caustics 38a, 38b have a depth of field, which may be defined on the basis of the Rayleigh length, for example. In some exemplary embodiments, the depth of field is defined by way of a percentage deviation of the beam width FWHM or FW@90% maximum along the short axis in the illumination direction 18. In particular, the depth of field can be defined as the distance between those points of the short-axis caustics 38a, 38b at which the respective short-axis beam width has increased by 1% or any other percentage between 1% and 10% in comparison with the short-axis beam width at the respective beam waist 42a, 42b. The depth of field in each case defines a process window with a process window length 46a, 46b for each individual illumination beam 24a, 24b.

As indicated in FIG. 3, the optical arrangement of some exemplary embodiments is configured to offset the first and the second beam caustic 38a, 38b by a distance 48 which is approximately of the order of the depth of field 46a, 46b. The device 10 has an increased process window 50 as a result of the superposition of the beam caustics 38a, 38b offset in the illumination direction 18.

In FIG. 1b, the effective diameter of the—preferably cylindrical—lens 30a is indicated at reference sign 52 in relation to the short axis. In some preferred exemplary embodiments, the laser beams to be reshaped illuminate the lens 30a and corresponding further lenses in the optical arrangement 22, for instance the lens 30b, into the peripheral region, that is to say for example over 70% or even 90% of the effective diameter 52. As a consequence, the depth of field of the illumination beams 24a, 24b is reduced, which is advantageous in order to minimize the offset 38 of the beam transformers. By way of example, the distance 38 can be approximately 250 mm in some exemplary embodiments in order to obtain a distance 48 between the beam caustics 38a, 38b of approximately 100 μm, since the distance 48 corresponds to the product of the offset 38 and the M² value M². The M² value specifies the divergence angle of a real laser beam in comparison with the divergence angle of an ideal Gaussian beam with the same diameter at the beam waist.

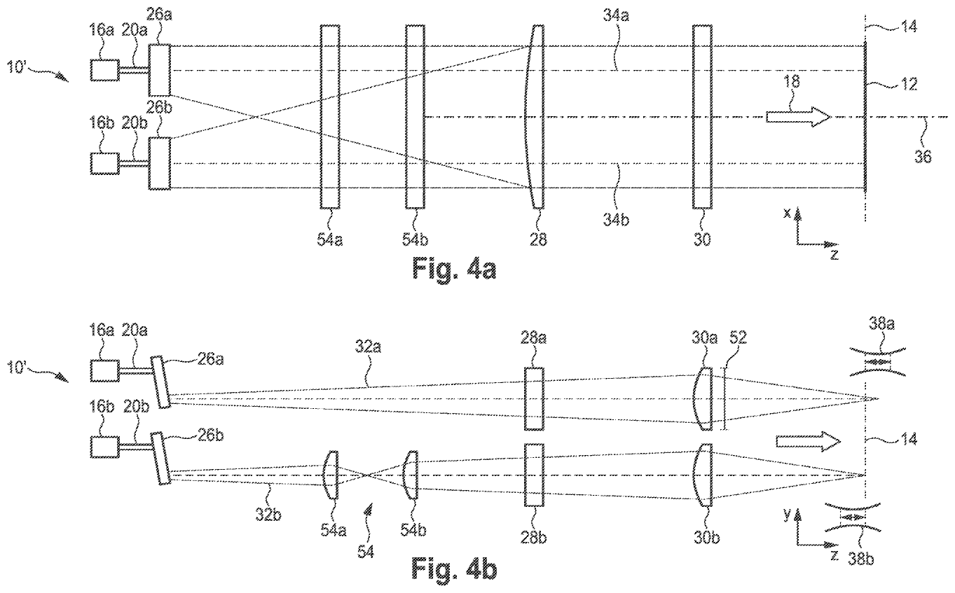

FIGS. 4a and 4b show a further exemplary embodiment of the device, denoted here by reference sign 10′. Otherwise, the same reference signs denote the same elements as previously. In the exemplary embodiment according to FIGS. 4a and 4b, the offset of the beam caustics 38a, 38b is obtained with the aid of an additional optical element 54 arranged in the second beam path 32b. In some exemplary embodiments, the additional optical element 54 can be arranged downstream of the beam transformer 26b in the second beam path 32b, as indicated in FIG. 4b. In other exemplary embodiments, the additional optical element 54 can be arranged upstream of the beam transformer 26b in the second beam path 32b. In some preferred exemplary embodiments, the additional optical element 54 can be a telescope arrangement having a first additional optical element 54a and a second additional optical element 54b. The additional optical elements 54a, 54b can be lens elements or mirror elements, in particular. On account of the additional optical element 54, the beam transformers 26a, 26b can be arranged “level” in relation to the system axis 36, and consequently be arranged without a relative offset 38. As indicated in FIG. 4b, the additional optical element 54 has an optical refractive power, which predominantly influences the short axis of the beam profile 40.

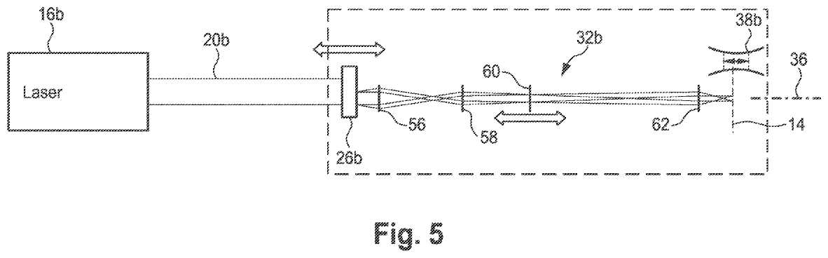

FIG. 5 shows a further exemplary embodiment of the device in a simplified representation of the beam path 32b in relation to the short axis. Optical elements for beam shaping along the long axis have not been shown here for simplification purposes. Otherwise, the same reference signs denote the same elements as previously. In this exemplary embodiment, the beam path 32b contains a short-axis telescope with lens elements 56, 58, which generates an intermediate image 60 along the beam path 32b upstream of the beam transformer 26b. The intermediate image 60 is imaged onto the work plane 14 with the aid of further lens elements 62. Such an exemplary embodiment is particularly advantageous if the beam profile in the region of the work plane 14 should be a top hat profile along the short axis, as is desirable in the case of SLA applications in particular. In this case, the offset of the beam caustic 38b can be obtained either by way of an offset of the beam transformer 26b, as explained above with reference to FIGS. 1a and 1b, and/or by a displacement of the intermediate image 60, which is possible by way of a suitable adjustment and/or dimensioning of the short-axis telescope with the lens elements 56, 58.

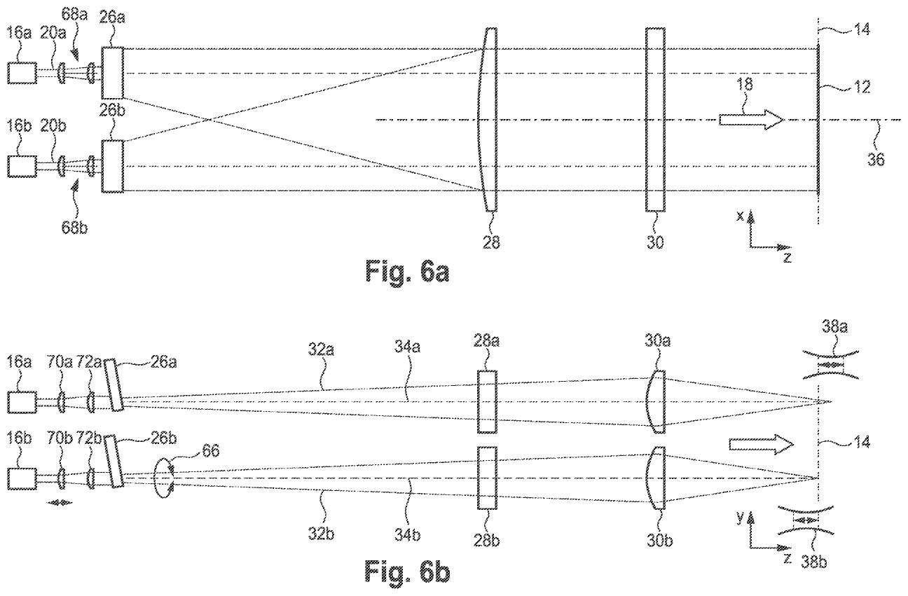

FIGS. 6a and 6b show a further exemplary embodiment of the device. The same reference signs denote the same elements as previously. In the exemplary embodiment according to FIGS. 6a and 6b, the relative offset of the beam caustics 38a, 38b is achieved by virtue of the beam transformer 26b in the second beam path 32b being rotated about the z-axis in comparison with the beam transformer 26a in the first beam path 32a, as indicated by an arrow 66 in FIG. 6b. The rotation 66 about the z-axis results in a vertical offset of the output-side beam packets and influences the edge steepness of the short-axis beam profile in the work plane 14. Details in this respect are described in documents DE 10 2018 115 126 B4 and WO 2019/243042 A1, the latter with the same priority, by the applicant, which are incorporated herein by reference. Moreover, the device in this exemplary embodiment in each case comprises a collimation optical unit 68a, 68b upstream of the respective beam transformer 26a, 26b. The respective collimation optical unit 68a, 68b collimates the respective raw laser beam 20a, 20b before it is incident on the respective beam transformer 26a, 26b. In a preferred variant of this exemplary embodiment, the respective collimation optical unit 68a, 68b contains a multiplicity of lenses 70a, 72a and 70b, 72b, respectively. Advantageously, at least one of the lenses in the second beam path 32b, for instance the lens 70b, is displaced in the z-direction relative to the corresponding lens 70a, with the result that the collimation of the respective raw laser beam 20a, 20b in the parallel beam paths 32a, 32b differ from one another. Together with the rotation 66 of the beam transformer 26b, a variation of the collimation as a result of displacing the lens 70b leads to a very advantageous displacement of the caustic 38b. In some exemplary embodiments, the lenses 70a, 72a or 70b, 72b can respectively form a telescope arrangement. The altered collimation may also be located virtually upstream of the respective beam transformer 26b.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A device for generating a laser line on a work plane, the device comprising:
a first laser light source configured to generate a first raw laser beam,
a second laser light source configured to generate a second raw laser beam, and
an optical arrangement configured to:
transport the first raw laser beam along a first beam path, and reshape the first raw laser beam along a first optical axis to form a first illumination beam with a first caustic and a first beam profile, and
transport the second raw laser beam along a second beam path, and reshape the second raw laser beam along a second optical axis to form a second illumination beam with a second caustic and a second beam profile,
wherein the first illumination beam and the second illumination beam are directed with overlap on the work plane and define a joint illumination direction, the first beam profile and the second beam profile each having a long axis with a long-axis beam width and a short axis with a short-axis beam width perpendicular to the joint illumination direction, and the first beam profile and the second beam profile jointly forming the laser line on the work plane, and
wherein the optical arrangement is configured to position the first caustic and the second caustic offset from one another in the illumination direction.

2. The device as claimed in claim 1, wherein the optical arrangement comprises a first beam transformer in the first beam path and a second beam transformer in the second beam path, the first beam transformer configured to reshape the first raw laser beam in order to generate the first beam profile, the second beam transformer configured to reshape the second raw laser beam in order to generate the second beam profile, wherein the first optical axis and the second optical axis define a joint system axis, and the first beam transformer and the second beam transformer are arranged offset relative to one another along the joint system axis.

3. The device as claimed in claim 1, wherein the optical arrangement comprises at least one beam transformer configured to reshape the first raw laser beam and/or the second raw laser beam in order to generate the first beam profile and/or the second beam profile, and wherein the optical arrangement further comprises, in the second beam path, an optical element configured to offset the second caustic relative to the first caustic.

4. The device as claimed in claim 1, wherein the first caustic defines a process window with a process window length in the illumination direction, and wherein the first caustic and the second caustic are offset in the illumination direction by a defined distance that is less than 1.5 times the process window length and greater than 0.5 times the process window length.

5. The device as claimed in claim 1, wherein the optical arrangement comprises at least one lens that has a predominant optical refractive power in relation to the short axis of the first beam profile and the second beam profile, the lens having an effective diameter in relation to the short axis, and the first illumination beam and/or the second illumination beam illuminating the lens over more than 50% of the effective diameter.

6. The device as claimed in claim 1, wherein the first beam path generates a first intermediate image, and the second beam path generates a second intermediate image, and wherein the first optical axis and the second optical axis define a joint system axis, the first intermediate image and the second intermediate image being arranged offset relative to one another along the joint system axis.

7. The device as claimed in claim 1, wherein the optical arrangement comprises a first beam transformer in the first beam path and a second beam transformer in the second beam path, the second beam transformer being rotated relative to the first beam transformer about the second optical axis.

8. The device as claimed in claim 1, wherein the optical arrangement focuses the first beam profile and the second beam profile onto the work plane, wherein neither the first beam path nor the second beam path has a determined stop.

9. The device as claimed in claim 1, wherein the optical arrangement superposes the first beam profile and the second beam profile along the respective long axis and along the respective short axis.
